(19) United States
(12) Patent Application Publication
(10) Pub. No.: US 2024/0103130 A1
(43) Pub. Date: Mar. 28, 2024

(54) FEATURE EXTRACTION FOR REMOTE SENSING DETECTIONS

(71) Applicant: SRI International, Menlo Park, CA (US)

(72) Inventor: Bradley J. Clymer, Austin, TX (US)

(21) Appl. No.: 18/250,933

(22) PCT Filed: Oct. 18, 2021
(86) PCT No.: PCT/US2021/055470

§ 371 Date: Apr. 27, 2023

Related U.S. Application Data
(60) Provisional application No. 63/107,013, filed on Oct. 29, 2020.

(51) Int. Cl. G01S 7/41

(52) U.S. Cl. CPC G01S 7/411

(57) ABSTRACT

An example radar target classification system for identifying classes of objects includes a cluster engine includes processing circuitry and configured to process radar data to determine a cluster of radar detections, the radar data being based on radio waves reflected from one or more objects over a time window. The example system includes a feature extraction engine comprising processing circuitry and configured to determine a plurality of statistical features based on the determined cluster of radar detections. The example system includes a classifier comprising processing circuitry and configured to classify a first object of the one or more objects based on the determined plurality of statistical features and to output an indication of a class of the first object.

This application claims the benefit of U.S. Provisional Application No. 63/107,013 by Clymer, entitled “FEATURE EXTRACTION FOR REMOTE SENSING DETECTIONS USING LOCAL STATISTICAL PROPERTIES OF GROUPS OF DETECTIONS,” and filed on Oct. 29, 2020. The entire content of Application No. 63/107,013 is incorporated herein by reference.

### GOVERNMENT RIGHTS

This invention was made with Government support under contract number FA4600-18-D-0001 awarded by the U.S. Strategic Command Joint Functional Component Command for Space. The Government has certain rights in this invention.

### TECHNICAL FIELD

This disclosure relates generally to techniques for identifying classes of objects using radar data.

### BACKGROUND

Past attempts to identify of classes of objects using radar data included Automatic Target Recognition techniques, such as time-frequency analysis and statistical techniques such as Maximum Likelihood Estimation.

### SUMMARY

In general, the disclosure describes techniques for identifying a class of an object using radar data. The techniques described herein may be used to identify a class of an object, such as a moving object, like a drone, by generating complex non-linear features with a relatively high predictive power from radar detection data. These techniques may be performed by reading and processing data files which may be stored on any given computer. These techniques may include generating a set of features which serve as an input to a machine learning architecture. Drones are relatively new objects and using past techniques to attempt to identify a drone may be unlikely to be successful as a past techniques may erroneously identify a bird as a drone (or vice versa), for drones may fly relatively low to the ground and may be relatively small like a bird.

For example, a system that applies techniques of this disclosure may treat statistical properties of a neighborhood of detections around a single detection as features of the single detection. For example, for a given single detection, the system may apply a clustering algorithm, e.g., Kth-Nearest-Neighbors (kNN), to find nearby detections in space within a specified time window. The set of detections may be referred to as a cluster of radar detections, which may be around the single detection. The system may apply principal component analysis, such as a singular value decomposition algorithm, to the positions within the cluster of radar detections to extract features, such as the eigenvectors and eigenvalues of the cluster's spatial covariance matrix.

Every radar detection may have magnitude information, as well as Doppler information. The system may use this information to derive a selectable set of features, such as mean, standard deviation, skewness, kurtosis, or the like. These features may be aggregated as a vector representing each point and be passed to a machine learning architecture. The machine learning architecture may be trained using a known object, such as a moving object, like a drone.

For example, a cluster engine may process radar returns (e.g., radio waves reflected from one or more objects) to determine a cluster of radar detections over a time window. A feature extraction engine may determine statistical features of the determined cluster. A classifier may classify an object of the one or more objects based on the determined plurality of statistical features and output an indication of a class of the object.

The techniques of this disclosure may provide one or more technical advantages for realizing at least one practical application. For example, classifying an object as described herein may improve automatic target recognition to, e.g., inform personnel of a potential or a non-potential threat. Compared to other techniques for classifying an object, the techniques of this disclosure are relatively accurate and may provide for more reliable classification of a detected object.

In an example, a radar target classification system includes a cluster engine comprising processing circuitry and configured to process radar data to determine a cluster of radar detections, the radar data being based on radio waves reflected from one or more objects over a time window; a feature extraction engine comprising processing circuitry and configured to determine a plurality of statistical features based on the determined cluster of radar detections; and a classifier comprising processing circuitry and configured to classify a first object of the one or more objects based on the determined plurality of statistical features and to output an indication of a class of the first object.

In an example, a method includes processing, by a computing system, radar data to determine a cluster of radar detections, the radar data being based on radio waves reflected from one or more objects over a time window; determining, by a computing system, a plurality of statistical features based on the determined cluster of radar detections; classifying, by a computing system, a first object of the one or more objects based on the determined plurality of statistical features; and outputting, by a computing system, an indication of a class of the first object.

In an example, a non-transitory computer-readable medium includes instructions that, when executed, cause one or more processors to process radar data to determine a cluster of radar detections, the radar data being based on radio waves reflected from one or more objects over a time window; determine a plurality of statistical features based on the determined cluster of radar detections; classify a first object of the one or more objects based on the determined plurality of statistical features; and output an indication of a class of the first object.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example classification system in accordance with the techniques of the disclosure.

FIG. 2 is a block diagram illustrating an example classification system of FIG. 1 in further detail in accordance with the techniques of the disclosure.

FIG. 3 is a conceptual diagram illustrating a cluster of radar detections according to the techniques of this disclosure.

FIG. 4 is a flowchart illustrating an example method for identification in accordance with the techniques of the disclosure.

Like reference characters refer to like elements throughout the figures and description.

### DETAILED DESCRIPTION

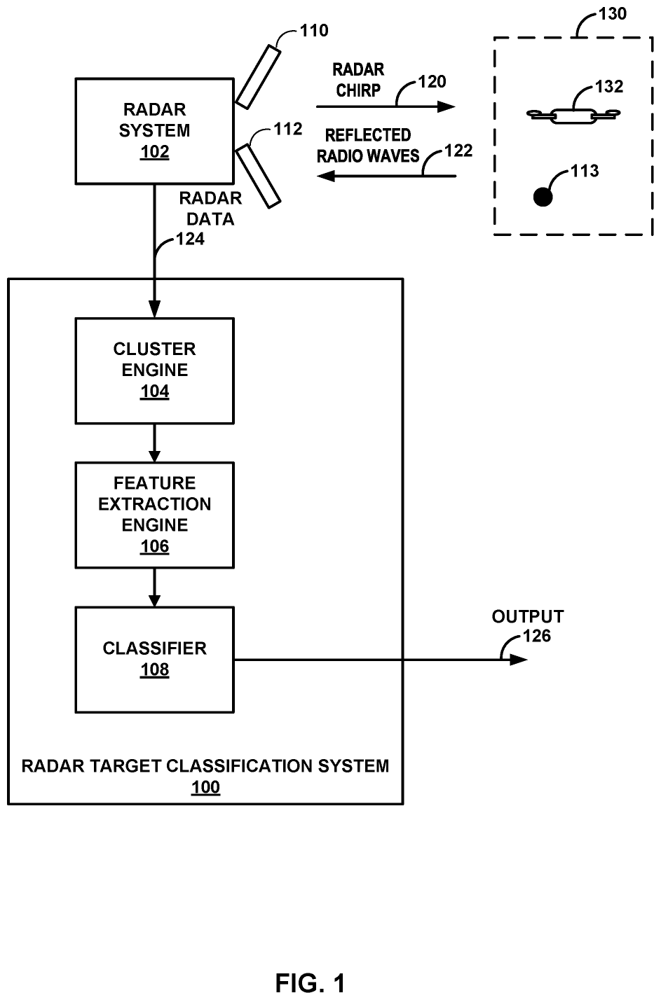

FIG. 1 is a block diagram illustrating an example radar target classification system 100 in accordance with the techniques of the disclosure. As shown, radar target classification system 100 includes cluster engine 104, feature extraction engine 106, and classifier 108. Three-dimensional space 130 is illustrated as including drone 132. However three-dimensional space 130 may include other objects, such as object 113 which may include one or more birds, insects, trees, buildings, vehicles (such as airplanes, helicopters, automobiles, or the like) and/or other objects. In some examples, three-dimensional space 130 may be an outdoor space, a range of vision of radar system 102, an indoor space, or any other three-dimensional space.

Radar system 102 may be configured to generate radar data 124. For example, radar system 102 may include an upper radar panel 110 and a lower radar panel 112 which each may be configured to transmit radar chirp 120 and receive reflected radio waves 122. Using two radar panels may provide some information regarding uncertainty or location.

In some examples, radar data 124 is a time-domain or frequency-domain signal. For example, radar system 102 may output radar chirp 120 to three-dimensional space 130. In this example, radar system 102 may detect reflected radio waves 122 that are reflected from one or more objects (e.g., drone 132) within three-dimensional space 130. In this example, radar system 102 may generate radar data 124 using reflected radio waves 122. Radar system 102 may use mm-wave radar, ultra-wide band (UWB), frequency-modulated continuous wave (FMCW), phase-modulated continuous wave (PMCW) or other type of radar for generating radar data 124. Radar data 124 may be based on radio waves reflected from one or more objects (e.g., drone 132).

Radar system 102 may act like a 1-pixel camera over time. From each radar chirp 120, radar system 102 may determine how long radar chirp 120 took to reach an object and one of reflected radio waves 122 to return from the object. From this information, radar system 102 may determine a distance that the object is from radar system 102. Radar system 102 may autocorrelate the returned signals over time using a plurality of reflected radio waves 122. Radar system 102 may transmit a few thousand radar chirps very quickly. For example, radar system 102 may determine where an object is in a velocity space using Doppler processing. Radar system 102 may apply a Fast Fourier Transform (FFT) to determine a cluster ridge in the middle of detections for static features. Radar system 102 may determine features, such as range, velocity, amplitude of a response, etc. from the detections.

Aspects of radar system 102 may be implemented in processing circuitry. For instance, radar system 102 may include, any one or more of a microprocessor, a controller, a digital signal processor (DSP), an application specific integrated circuit (ASIC), a field-programmable gate array (FPGA), or equivalent discrete or integrated logic circuitry.

When radar system 102 sends out radar chirp 120, radar system 102 may receive back reflected radio waves 122 and may reduce reflected radio waves 122 to a single detection. From this single detection, radar system 102 may determine Doppler velocity, position, and amplitude. However, it may be difficult to classify the single detection based on the Doppler velocity, position, and amplitude of the single detection. For example, a bird will have a very different reflectivity than a truck, which may be one technique to attempt to classify the single detection. However, different birds (e.g., a white bird and a black bird) may have very different reflectivities as well. Additionally, objects may overlap or have different coatings or aspects of the surface area of the object that may be different even when the objects are of a same class. Thus, simply using a radar cross section for classifying a detected object may not be very accurate. Rather a radar target classification system such as radar target classification system 100 may be desirable in that it may utilize groups of radar detections around a single detection to classify an object that is the subject of the single detection.

Radar target classification system 100 may be configured to receive radar data 124 from radar system 102 and to output indication 126 of a class (e.g., drone) of an object (e.g., drone 132). Examples of indication 126 of a class of an object include, but are not limited to, drone, not drone, particular type of drone, bird, insect, fixed wing vehicle, helicopter-type vehicle airplane, automobile, truck, unusual payload, or any other potential class of objects which may reflect radio waves. Radar target classification system 100 may include a computing system having one or more computing devices which may include processing circuitry, such as any one or more of a microprocessor, a controller, a digital signal processor (DSP), an application specific integrated circuit (ASIC), a field-programmable gate array (FPGA), or equivalent discrete or integrated logic circuitry. For example, radar target classification system 100 may be a single computing device or a plurality of computing devices. In some examples, aspects of radar target classification system 100, cluster engine 104, feature extraction engine 106, and/or classifier 108 may be distributed among a plurality of processing circuitries.

Radar target classification system 100 may include cluster engine 104, feature extraction engine 106, and classifier 108. Each of cluster engine 104, feature extraction engine 106, and classifier 108 may comprise processing circuitry and may represent software instructions executable by and in combination with one of more processors or other processing circuitry of radar target classification system 100. Rather than utilize a single detection to attempt to classify an object, radar target classification system 100 may utilize groups of detections in a relatively small time window around the object that is being classified.

For example, cluster engine 104 may determine a dataset within a window of time. This dataset may include K-nearest-neighbors in time to a detection of interest. Cluster engine 104 may determine the distances of each data point in the dataset. Cluster engine 104 may use the determined distances to select the K-nearest distance neighbors from a detection of interest. These K-nearest distance neighbors may be referred to as a cluster of radar detections. Feature extraction engine 106 may use the cluster of radar detections to determine statistical features associate with the cluster of radar detections. For example, feature extraction engine 106 may perform a principal component analysis on the spatial features. These determined statistical features may be used by classifier 108 to classify an object, such as drone 132.

Cluster engine 104 may be configured to process radar data 124 to determine a cluster of radar detections. For example, cluster engine 104 may determine a local cluster or neighborhood of radar detections within a predetermined time window. For example, the time window may be large enough such that the determined cluster of radar detections includes at least three radar detections. In some examples, cluster engine 104 applies a clustering algorithm to radar data 124 in a time domain to determine the time window and applies the clustering algorithm in a spatial domain within the time window to determine the cluster of radar detections. In some examples, the clustering algorithm includes a K-nearest-neighbors algorithm.

In some examples, to determine the cluster, cluster engine 104 determines a number associated with nearest neighbors in time, for example, the nearest 64 neighbors. This number may be stored in memory of radar target classification system 100 (not shown in FIG. 1). Cluster engine 104 may determine a time neighborhood matrix, wherein the time neighborhood matrix size is a number of points of radar data 124 by the number associated with the nearest neighbors in time and wherein each row of the time neighborhood matrix includes indices of the K-nearest neighbors in time for a corresponding point of radar data 124. Cluster engine 104 may, based on the time neighborhood matrix, determine a set of time points. Cluster engine 104 may trim the set of time points to be within the time window. Cluster engine 104 may determine a set of spatially nearest neighbors based on the time points within the time window. Cluster engine 104 may output the determined cluster of radar detections to feature extraction engine 106.

For example, cluster engine 104 may utilize a parameter k_t for a number of nearest neighbors in time. Cluster engine 104 may also utilize a parameter k_n for number of nearest neighbors in space. In some examples, k_n is relatively much smaller than k_t. For example, for a dataset X having N data points, which each may have a timestamp, cluster engine 104 may determine a time neighborhood matrix KT, of size N×k_t. Cluster engine 104 may use a K-nearest-neighbors algorithm, and populate each row of time neighborhood matrix KT with the indices of each point's K-nearest neighbors in time. Cluster engine 104 may, for each data point x in the overall dataset X, using matrix KT, select a set of indices s_i of each data point's time neighbors. Cluster engine 104 may, using s_i to index into dataset X, generate a set of time-local points x_t1. From x_t1, cluster engine 104 may trim all points to be within a time window, such as a 3 second time window. Cluster engine 104 may, again using the K-nearest-neighbors algorithm, generate a set x_s1 of spatially-local data points, from the time-trimmed x_t1. This set x_s1 may represent a cluster of radar detections. In some examples, cluster engine 104 may apply an inverse FFT to remove a clutter ridge from the cluster.

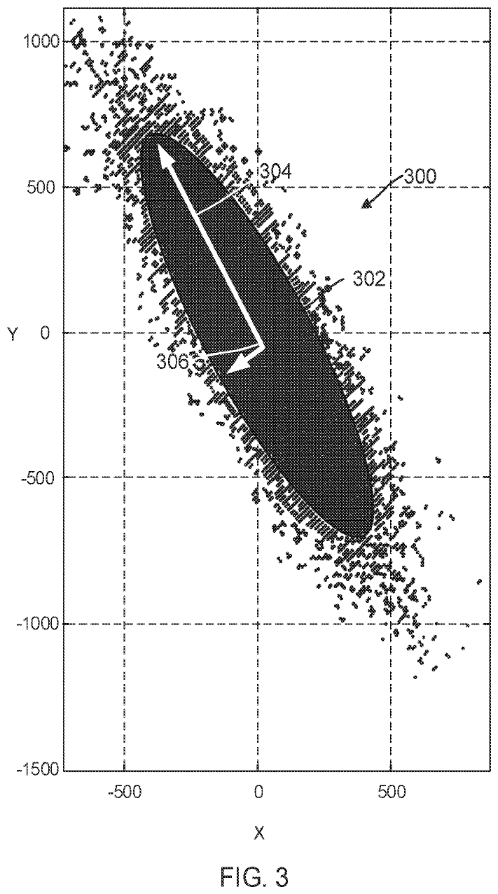

Feature extraction engine 106 may be configured to determine a plurality of statistical features of the determined cluster of radar detections. Such features may include at least one of a lambda of the determined cluster, a mean of velocities of the determined cluster, a standard deviation of velocities of the determined cluster, a mean of magnitudes associated with lower radar panel 112 of radar system 102, or a standard deviation of magnitudes associated with the lower radar panel 112 of radar system 102. A lambda is a statistical feature of the determined cluster, such as an eigenvector scaled by an eigenvalue. For example, a lambda may include the first eigenvalue of the covariance of the x, y, z points of the determined cluster. In a three-dimensional space, such as three-dimensional space 130, there may be three lambdas. Lambda 1 is the largest lambda (e.g., the most significant variation in the cluster of radar detections), lambda 2 is the next largest lambda, and lambda 3 is the smallest lambda. Each of the lambdas may be orthogonal to each other. Eigenvalues of the principal component analysis may provide an indication of shape of an object, such as drone 132. Lambdas will be further explained herein with respect to FIG. 3.

Example statistical features of the cluster of radar detections may include lambda 1 raw (the determined lambda 1 without normalization), lambda 2 raw, lambda 3 raw, lambda 1 normalized (lambda 1 divided by the sum of all lambdas), lambda 2 normalized, lambda 3 normalized, velocity associated with a first detection within the cluster of radar detections (e.g., velocity of a first object under test) (hereinafter “velocity”), mean of velocities of the other detections within the cluster of detections (hereinafter “mean of velocities”), standard deviation of velocities, magnitude of the first detection (hereinafter “magnitude”) from lower radar panel 112, magnitude from upper radar panel 110, mean of magnitudes of the other detections within the cluster of detections (hereinafter “mean of magnitudes”) from lower radar panel 112, standard deviation of magnitudes from lower radar panel 112, mean of magnitudes from upper radar panel 110, standard deviation of magnitudes from upper radar panel 110, and whether the radar signal is jammed. In some examples, whether the radar signal is jammed may not be used. The most useful features for classifying a drone may include lambda 1 raw, standard deviation of determined velocities, mean of determined velocities, mean of magnitudes from lower radar panel 112, and standard deviation of magnitudes from lower radar panel 112. In some examples, the features may be weighted as follows: lambda 1 raw (68%), lambda 2 raw (1%), lambda 3 raw (0%), lambda 1 normalized (0%), lambda 2 normalized (0%), lambda 3 normalized (0%), velocity (0.5%), mean of velocities (4.5%), standard deviation of velocities (16.1%), magnitude from lower radar panel 112 (0.1%), magnitude from upper radar panel 110 (0.2%), mean of magnitudes from lower radar panel 112 (4.1%), standard deviation of magnitudes from lower radar panel 112 (2.2%), mean of magnitudes from upper radar panel 110 (0.5%), standard deviation of magnitudes from upper radar panel 110 (0.1%), and whether the radar signal is jammed (2.5%).

In some examples, feature extraction engine 106 may include a singular value decomposition algorithm. Feature extraction engine 106 may be configured to apply the singular value decomposition algorithm to the determined cluster of radar detections to determine a plurality of statistical features. For example, the plurality of statistical features may include a plurality of eigenvectors and a plurality of eigenvalues based on the determined cluster of radar detections. Feature extraction engine 106 may scale the eigenvectors by eigenvalues. For example, feature extraction engine 106 may take set x_s1 discussed above, generate statistical features associated with set x_s1 and assign those features back to point x. Feature extraction engine 106 may output the determined statistical features, such as the scaled eigenvectors and/or other determined statistical features of the cluster of radar detections, to classifier 108.

Classifier 108 may be configured to classify a first object of the one or more objects (e.g., drone 132) based on the determined plurality of statistical features. In some examples, classifier 108 may include at least one of a gradient boost classifier, an XGBoost classifier, a multilayer perceptron (MLP) network, or a transformer network. In some examples, classifier 108 includes a machine learning classifier. Classifier 108 may also be configured to output indication 126 of a class of the first object, for example, a moving object, such as a drone. For example, radar target classification system 100 may, more accurately than previous classification systems, distinguish between a large object and a fast moving object and more accurately identify a class of an object reflecting radar signals, such as drone 132.

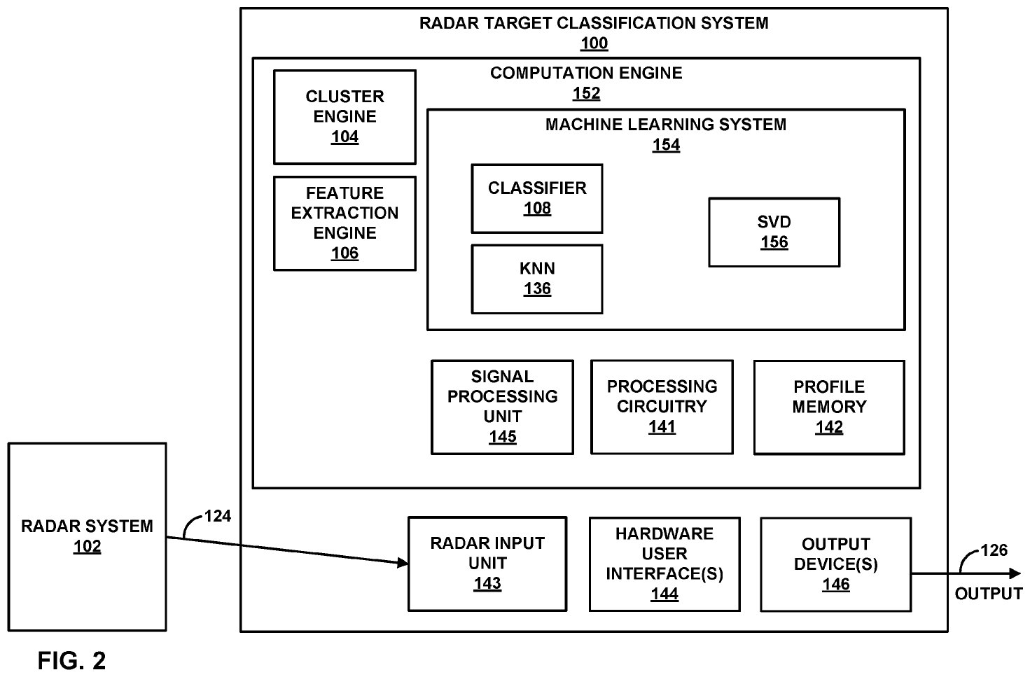

FIG. 2 is a block diagram illustrating an example radar target classification system 100 FIG. 1 in further detail in accordance with the techniques of the disclosure. In the example of FIG. 2, radar target classification system 100 includes computation engine 152, profile memory 142, radar input unit 143, signal processing unit 145, processing circuitry 141, one or more hardware user interfaces 144 (hereinafter “hardware user interface 144”), and one or more output devices 146 (hereinafter “output device 146”). In the example of FIG. 2, a user of radar target classification system 100 may provide input to radar target classification system 100 via one or more input devices (not shown) such as a keyboard, a mouse, a microphone, a touch screen, a touch pad, or another input device that is coupled to radar target classification system 100 via one or more hardware user interfaces 144.

Output device 146 may include a display, sound card, video graphics adapter card, speaker, presence-sensitive screen, one or more USB interfaces, video and/or audio output interfaces, or any other type of device capable of generating tactile, audio, video, or other output. Output device 146 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. Output device 146 may be configured to output an indication of a class of an object.

Radar target classification system 100, in some examples, includes radar input unit 143. Radar input unit 143 is configured to receive electrical signal input from radar system 102, and convert the electrical signal input into a form usable by radar target classification system 100. For example, radar input unit 143 may include software or hardware configured to convert a received signal input from an analog signal to a digital signal. In another example, radar input unit 143 may include software or hardware configured to compress, decompress, transcode, encrypt, or decrypt a received signal input into a form usable by radar target classification system 100. In another example, radar input unit 143 may include a network interface device to receive packetized data representative of a time-domain or frequency-domain signal generated by sensor(s) 102. In such examples, an intermediate device may packetize radar data 124 to produce the packetized data and send the packetized data to radar target classification system 100. In this manner, radar input unit 143 may be configured to interface with, or communicate with, radar system 102 that outputs a time-domain or frequency-domain signal.

Radar system 102 may generate radar data 124. Signal processing unit 145 may obtain radar data 124 received via radar input unit 143. In some examples, signal processing unit 145 may process radar data 124. Signal processing unit 145 may comprise processing circuitry 141 and may represent software executable by and in combination with processing circuitry 141, or a combination of hardware and software. For instance, signal processing unit 145 may include one or more co-processors, such as an Application-Specific Integrated Circuit, for performing FFTs or inverse FFTs.

Computation engine 152 may process radar data 124 using machine learning system 154. Machine learning system 154 may comprise processing circuitry 141 and may represent software instructions executable by and in combination with processing circuitry 141. Computation engine 152 may process radar data 124 using machine learning system 154 to match a statistical features of a determined cluster of radar detections around drone 132 to statistical features of a class of objects, such as a drone learned by the machine learning system 154. In some examples, profile memory 142 may store statistical features of different classes of objects. In some examples, profile memory 142 may store data indicating or representative of one or more classes of objects identifiable by the machine learning system 154. For example, such data for a class of objects may include statistical features of the object, such as eigenvectors and eigenvalues (e.g., lambdas), velocities, magnitudes, and other features discussed herein, generated by feature extraction engine 106.

As shown, machine learning system 154 may include K-nearest-neighbors algorithm 136, singular value decomposition algorithm 156, and classifier 108. Computation engine 152 may be configured to apply machine learning system 154 to radar data 124 to identify drone 132. For example, computation engine 152 may be configured to apply machine learning system 154 that learns one of more features of a first object, such as drone 132, from radar data 124. For example, cluster engine 104 may determine a cluster of radar detections using K-nearest-neighbors algorithm 136 and feature extraction engine 106 may extract one of more features of a known object, such as a known drone, from the cluster of radar detections and provide the one or more features to machine learning system 154 to train classifier 108. In this example, computation engine 152 may determine a classification of drone 132 using a combination of results from K-nearest-neighbors algorithm 136, singular value decomposition algorithm 156, and classifier 108.

Although machine learning system 154 is described as being implemented using specific algorithms in the example of FIG. 2, machine learning system 154 may apply other types of machine learning to train one or more models capable of being used to classify an object. For example, machine learning system 154 may apply one or more of deep neural network, naïve Bayes, decision trees, linear regression, support vector machines, neural networks, k-Means clustering, Q-learning, temporal difference, deep adversarial networks, or other supervised, unsupervised, semi-supervised, or reinforcement learning algorithms to train one or more models for classifying an object.

For example, when training machine learning system 154, a person may pilot a known drone having a global positioning satellite (GPS) detector onboard. Computation engine 152 may match detections in a cluster of radar detections at a moment in time at a moment in time where the detections to a known location of the drone based on detected GPS coordinates. Feature extraction engine 106 may extract features of such a cluster of detections, train classifier 108 on such features, and store such features in profile memory 142 as a drone class. In order to prevent or mitigate against information leakage and to reduce cognitive overload, which may negatively affect classification, rather than pass the detections themselves to classifier 108, feature extraction engine 106 may pass one or more determined features of the cluster of radar detections to classifier 108. In this way, radar target classification system 100 may provide more reliable classification of drone 132.

In some examples, computation engine 152 may be robust to a presence and/or motion of objects in addition to drone 132. For example, three-dimensional space 130 may include object 113. In this example, radar target classification system 100 may accurately classify drone 132 regardless of the presence and/or a motion of object 113. More specifically, for example, radar data 124 may indicate a class of object 113 as well as drone 132. In this example, computation engine 152 may accurately classify drone 132 based on radar data 124. For instance, machine learning system 154 may accurately classify drone 132 regardless of the presence and/or motion of object 113. For example, radar data 124 forming multiple clusters of radar detections may be processed serially (e.g., in the order of the time represented by the clusters) to train machine learning system 154 to learn correlate features of the clusters to drone 132. Consequently, an accuracy of computation engine 152 to identify drone 132 may exceed that of previous radar target classification systems.

FIG. 3 is a conceptual diagram illustrating a cluster of radar detections according to the techniques of this disclosure. The dots in FIG. 3 represent data points in dataset 300. Dataset 300 may be an example of a cluster of radar detections determined by cluster engine 104. In this example, each of the data points has two properties: an x value and a y value. While FIG. 3 is described with respect to a two-dimensional dataset for ease of illustration, these techniques may be extended to be a three-dimensional data set including a z value which may represent three-dimensional space 130. If the properties of the data set vary in a related way, there is a covariance. In FIG. 3, a trend can be seen that as the value of x increases, the value of y decreases. Feature extraction engine 106 may apply singular value decomposition algorithm 156 to the dataset to determine features of dataset 300. Such features may include eigenvectors Λ₁ and Λ₂ and eigenvalues λ₁ and λ₂. For example, the eigenvectors are the direction of the principal variance of the dataset and the eigenvalues are (conceptually) the length of the vectors. Feature extraction engine 106 may scale the eigenvectors by their corresponding eigenvalues to determine principal features of dataset 300. For example, feature extraction engine 106 may scale eigenvector Λ₁ by eigenvalue λ₁ to generate lambda 1 304, which is the longest lambda of FIG. 3. Feature extraction engine 106 may scale eigenvector Λ₂ by eigenvalue λ₂ to generate lambda 2 306. Lambda 1 304 and lambda 2 306 are orthogonal to each other. In the example where the dataset is a three-dimensional data set, feature extraction engine 106 may determine a lambda 3 which will be orthogonal to both lambda 1 304 and lambda 2 306. The longest scaled eigenvector of a dataset is referred to herein as lambda 1 and the next longest scaled eigenvector of the dataset is referred to herein as lambda 2. In the example where the dataset is a three-dimensional data set, the third longest scaled eigenvector is referred to herein as lambda 3. These lambda features also describe the best-fit ellipse 302 to describe dataset 300. This best-fit ellipse minimizes the mean-squared distance from each point in the ellipse. In the example where the dataset is a three-dimensional data set, the lambdas would describe the best-fit ovoid.

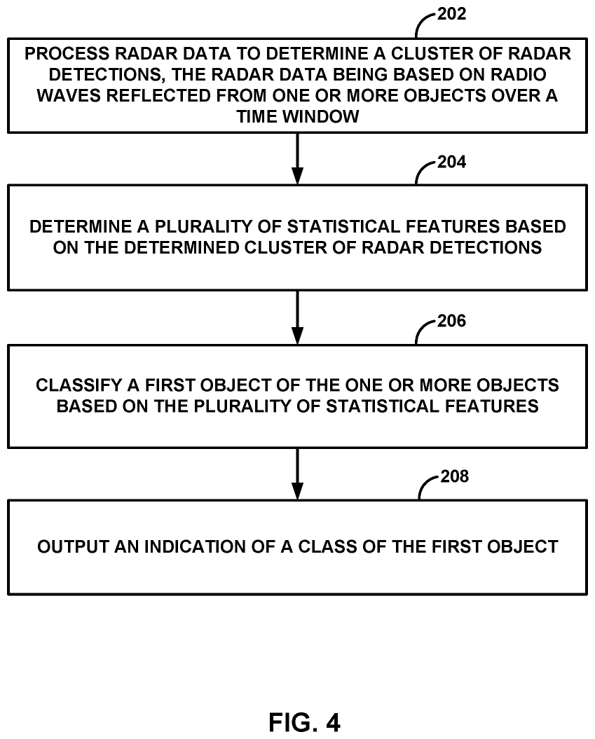

FIG. 4 is a flow diagram illustrating example radar target classification techniques of this disclosure. Cluster engine 104 may process radar data to determine a cluster of radar detections, the radar data being based on radio waves reflected from one or more objects over a time window (202). For example, cluster engine 104 may apply a clustering algorithm to radar data 124 in a time domain to determine the time window and apply the clustering algorithm in a spatial domain within the time window to determine the cluster of radar detections. In some examples, the cluster of radar detections comprises at least three radar detections. In some examples, the clustering algorithm is K-nearest-neighbors algorithm 136.

In some examples, cluster engine 104 may determine a number associated with nearest neighbors in time. Cluster engine 104 may, determine a time neighborhood matrix, wherein the time neighborhood matrix size is a number of points of the radar data by the number associated with the nearest neighbors in time and wherein each row of the time neighborhood matrix comprises indices of the K-nearest neighbors in time for a corresponding point of the radar data. Cluster engine 104 may, based on the time neighborhood matrix, determine a set of time points. Cluster engine 104 may trim the set of time points to be within the time window. Cluster engine 104 may determine a set of spatially nearest neighbors based on the time points within the time window.

Feature extraction engine 106 may determine a plurality of statistical features based on the determined cluster of radar detections (204). For example, feature extraction engine may be configured to apply singular value decomposition algorithm 156 to the determined cluster of radar detections. In some examples, feature extraction engine 106 applying the singular value decomposition algorithm 156 to the determined cluster of radar detections determines a plurality of eigenvectors and a plurality of eigenvalues. In some examples, the plurality of statistical feature includes at least one of a lambda of the determined cluster, a mean of velocities of the determined cluster, a standard deviation of velocities of the determined cluster, a mean of magnitudes associated with lower radar panel 112, or a standard deviation of magnitudes associated with lower radar panel 112. For example, the lambda may include a first eigenvalue of the covariance of x, y, z points of the determined cluster.

Classifier 108 may classify a first object of the one or more objects based on the plurality of statistical features (206). For example, classifier 108 may classify the first object based on the plurality of statistical features using at least one of a gradient boost classifier, an XGBoost classifier, a multilayer perceptron (MLP) network, or a transformer network. In some examples, classifier 108 comprises a machine learning classifier.

Classifier 108 may output an indication of a class of the first object (208). For example, classifier 108 may output an indication of drone as the class of the drone 132 to a display for display to personnel present near radar system 102 and/or radar target classification system 100, or in another location where personnel may be monitoring output of radar system 102 and/or radar target classification system 100. In some examples, the class of the first object includes a moving object, such as a drone.

Techniques for using matching or classifying as a way to achieve identification are described above. It is anticipated that in many occasions, a 100% match may not occur. Thus, radar target classification system 100 may allow a threshold to be set such that if the result of the matching operation is within this threshold, then a match is determined. To illustrate this with an example, if statistical features extracted from a cluster of radar detections have a 90% correlation to statistical features that were used to train classifier 108, and if the threshold for a match was set to 85%, then a match is declared. Thus, radar target classification system 100 may allow such thresholds to be set for the various different types of signals that may be used for matching.

In addition to the thresholds, various statistical parameters may be used for classification. Radar target classification system 100 may allow programming of the which of the statistical parameters and/or weights of those statistical parameters that have to match before an object is classified.

The above examples, details, and scenarios are provided for illustration, and are not intended to limit the disclosure in any way. Those of ordinary skill in the art, with the included descriptions, should be able to implement appropriate functionality without undue experimentation. References in the specification to “an embodiment,” “configuration,” “version,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory. Modules, data structures, function blocks, and the like are referred to as such for ease of discussion, and are not intended to imply that any specific implementation details are required. For example, any of the described modules and/or data structures may be combined or divided into sub-modules, sub-processes or other units of computer code or data as may be required by a particular design or implementation. In the drawings, specific arrangements or orderings of schematic elements may be shown for ease of description. However, the specific ordering or arrangement of such elements is not meant to imply that a particular order or sequence of processing, or separation of processes, is required in all embodiments.

In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure. This disclosure is to be considered as exemplary and not restrictive in character, and all changes and modifications that come within the spirit of the disclosure are desired to be protected.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

While this disclosure primarily discusses classification techniques based on radar data, in some examples, such techniques may be used with other sensors, such as lidar, optical, vibrational imaging, passive radar, unmanned aircraft systems control signals, or the like.

What is claimed is:

1. A radar target classification system for identifying classes of objects, the radar target classification system comprising:
a cluster engine comprising processing circuitry and configured to process radar data to determine a cluster of radar detections, the radar data being based on radio waves reflected from one or more objects over a time window;
a feature extraction engine comprising processing circuitry and configured to determine a plurality of statistical features based on the determined cluster of radar detections; and
a classifier comprising processing circuitry and configured to classify a first object of the one or more objects based on the determined plurality of statistical features and to output an indication of a class of the first object.

2. The radar target classification system of claim 1, wherein the cluster of radar detections comprises at least three radar detections.

3. The radar target classification system of claim 1, wherein the plurality of statistical features comprises at least one of a lambda of the determined cluster, a mean of velocities of the determined cluster, a standard deviation of velocities of the determined cluster, a mean of magnitudes associated with a lower radar panel, or a standard deviation of magnitudes associated with the lower radar panel.

4. The radar target classification system of claim 1, wherein to determine the cluster of radar detections, the cluster engine is configured to apply a clustering algorithm to the radar data in a time domain to determine the time window and to apply the clustering algorithm in a spatial domain within the time window to determine the cluster of radar detections.

5. The radar target classification system of claim 4, wherein the clustering algorithm comprises a K-nearest-neighbors algorithm.

6. The radar target classification system of claim 1, wherein to determine the cluster of radar detections, the cluster engine is configured to:
determine a number associated with nearest neighbors in time;
determine a time neighborhood matrix, wherein a time neighborhood matrix size is a number of points of the radar data by the number associated with the nearest neighbors in time, and wherein each row of the time neighborhood matrix comprises indices of the K-nearest neighbors in time for a corresponding point of the radar data;
based on the time neighborhood matrix, determine a set of time points;
trim the set of time points to be within the time window; and
determine a set of spatially nearest neighbors based on the time points within the time window.

7. The radar target classification system of claim 1, wherein to determine a plurality of statistical features of the determined cluster, the feature extraction engine is configured to apply a singular value decomposition algorithm to the determined cluster of radar detections.

8. The radar target classification system of claim 7, wherein the feature extraction engine is configured to apply the singular value decomposition algorithm to the determined cluster of radar detections to determine a plurality of eigenvectors and a plurality of eigenvalues.

9. The radar target classification system of claim 1, wherein the classifier comprises a machine learning classifier.

10. The radar target classification system of claim 1, wherein the class of the first object comprises a moving object.

11. A method of radar target classification comprising:
processing, by a computing system, radar data to determine a cluster of radar detections, the radar data being based on radio waves reflected from one or more objects over a time window;
determining, by the computing system, a plurality of statistical features based on the determined cluster of radar detections;
classifying, by the computing system, a first object of the one or more objects based on the determined plurality of statistical features; and
outputting, by the computing system, an indication of a class of the first object.

12. The method of claim 11, wherein the plurality of statistical features comprises at least one of a lambda of the determined cluster, a mean of velocities of the determined cluster, a standard deviation of velocities of the determined cluster, a mean of magnitudes associated with a lower radar panel, or a standard deviation of magnitudes associated with the lower radar panel.

13. The method of claim 11, wherein determining the cluster of radar detections comprises:
applying, by the computing system, a clustering algorithm to the radar data in a time domain to determine the time window; and
applying, by the computing system, the clustering algorithm in a spatial domain within the time window to determine the cluster of radar detections.

14. The method of claim 13, wherein the clustering algorithm comprises a K-nearest-neighbor algorithm.

15. The method of claim 11, wherein determining the cluster comprises:
determining a number associated with nearest neighbors in time;
determining a time neighborhood matrix, wherein a time neighborhood matrix size is a number of points of the radar data by the number associated with the nearest neighbors in time and wherein each row of the time neighborhood matrix comprises indices of the K-nearest neighbors in time for a corresponding point of the radar data;
determining, based on the time neighborhood matrix, a set of time points;
trimming the set of time points to be within the time window; and
determining a set of spatially nearest neighbors based on the time points within the time window.

16. The method of claim 11, wherein determining a plurality of statistical features based on the determined cluster of radar detections comprises applying a singular value decomposition algorithm to the cluster of radar detections.

17. The method of claim 16, wherein applying the singular value decomposition algorithm to the cluster of radar detections comprises determining a plurality of eigenvectors and a plurality of eigenvalues.

18. The method of claim 11, wherein classifying the first object comprises classifying with a machine learning classifier.

19. The method of claim 11, wherein the class of the first object comprises a moving object.

20. A non-transitory computer-readable storage medium storing instructions that, when executed by one or more processors, cause the one or more processors to:
process radar data to determine a cluster of radar detections, the radar data being based on radio waves reflected from one or more objects over a time window;
determine a plurality of statistical features based on the determined cluster of radar detections;
classify a first object of the one or more objects based on the determined plurality of statistical features; and
output an indication of a class of the first object.
